(19) United States
(12) Patent Application Publication
(10) Pub. No.: US 2010/0094534 A1
(43) Pub. Date: Apr. 15, 2010

(54) ELECTRONIC MAP ROUTES BASED ON ROUTE PREFERENCES

(75) Inventors: Indran Naick, Cedar Park, TX (US); Jeff K. Wilson, Austin, TX (US)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/250,038

(22) Filed: Oct. 13, 2008

(51) Int. Cl. G01C 21/34

(52) U.S. Cl. 701/200

(57) ABSTRACT

Users typically use routing systems including GPS systems, handheld devices, and online map routing services to navigate from one point to another (sometimes through several intermediate points). Routing systems typically calculate a route based on information derived from roadway maps. Typically, routing options focus on determining a shortest route, a route that can be traversed in the least amount of time, a route with the least use of freeways and toll roads, etc. Although routing options may be oriented towards helping users save time and money, the directions are generally confusing and do not take the users' driving preferences into account. Functionality can be implemented to determine a simplified route, regardless of time and distance, may present a driver with the least challenging set of directions. This may prevent the driver from missing a direction and navigating off the path.

### BACKGROUND

Embodiments of the inventive subject matter generally relate to the field of electronic maps, and more particularly, to generating routes in electronic maps based on route preferences.

Routing systems (e.g., GPS systems, handheld devices, and online map services) provide mechanisms to navigate from one point to another by calculating paths based on information derived from roadway maps. Routing systems have usability features to automatically calculate the type of directions desired. The usability features typically include the following: 1) shortest distance (using an algorithm to determine the shortest distance from one point to the next); 2) least amount of travel time (using an algorithm to determine the shortest distance based on the road's speed limit and distance, and calculating the resulting driving time); 3) least use of freeways; and 4) least use of toll roads.

The routing systems typically include cartographic maps and map databases to determine an appropriate driving route. The map databases represent a network of roads and include information about toll roads, speed limits, highway exit points, and points of interest. The map databases also include points on a map (also known as waypoints) represented in the form of latitudes and longitudes, UTM coordinates, or geospatial coordinates. Some examples of waypoints include points of interest (e.g., museums, restaurants, railways, exit points, etc.), satellites, a user-entered destination, and a fixed reference point along a route. These waypoints can be marked on maps in the routing systems.

A route is a series of two or more waypoints. The routing systems first determine a set of waypoints between a starting point and a destination point. Next, the routing systems guide a user to a nearest waypoint along the route, then to the next one in turn, until the user reaches the destination point. The routing systems resolve the starting point and the destination point into its nearest known waypoints on the network and use a “great circle routing algorithm” to determine a route between two points. Some routing systems also use a search algorithm to search a graph of nodes (representing waypoints) and edges (representing paths between waypoints). Some examples of search algorithms that can be used to determine a route between two points are Dijkstra's algorithm (to determine the shortest path), A* algorithm (to determine the shortest path along a weighted graph), bidirectional search algorithm, etc.

### SUMMARY

Embodiments include a method directed to generating routes in electronic maps based on route preferences. A route is a set of waypoints between a starting point and a destination point on an electronic map, while a waypoint is a geographic point on the electronic map. A path between two waypoints comprises one or more roads. One or more route preferences are determined. Road metadata, associated with one or more paths between the starting point and the destination point, is also determined. A route is determined based on the route preferences and road metadata.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating a client-server system configured to determine and present a tailored route.

FIG. 2 is a flow diagram illustrating example operations for determining a tailored route for navigation.

FIG. 3 is an example conceptual diagram depicting a reconfiguration of a route to reflect additional routing options.

FIG. 4 is an example block diagram illustrating a standalone system configured to determine and present a tailored route.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. In some instances, well-known instruction instances, protocols, structures, and techniques have not been shown in detail in order not to obfuscate the description.

### Introduction

Users typically use GPS systems, handheld devices, and online map routing services to navigate from one point to another (sometimes through several intermediate points). Routing systems typically calculate a route based on information derived from roadway maps, and may even have a set of usability features to automatically calculate the type of directions desired. Current routing options are useful in determining the fastest or least expensive route between two points on a map. Even with the current routing options, however, users often miss turns, take the wrong turn, or get confused by roads having similar names. Users may also get confused while a GPS routing system tries to determine if the user is off-route and recalculates the route. A routing system that generates a simplified and/or tailored route can present a driver with the least challenging and/or most user-friendly set of directions. The routing system can determine a simple route, perhaps simple from the perspective of the user, based on the user's route preferences. The routing system may determine a route that is not necessarily simple to everyone, but that is simple for a particular user, at least partially because it accommodates the preferences of the particular user.

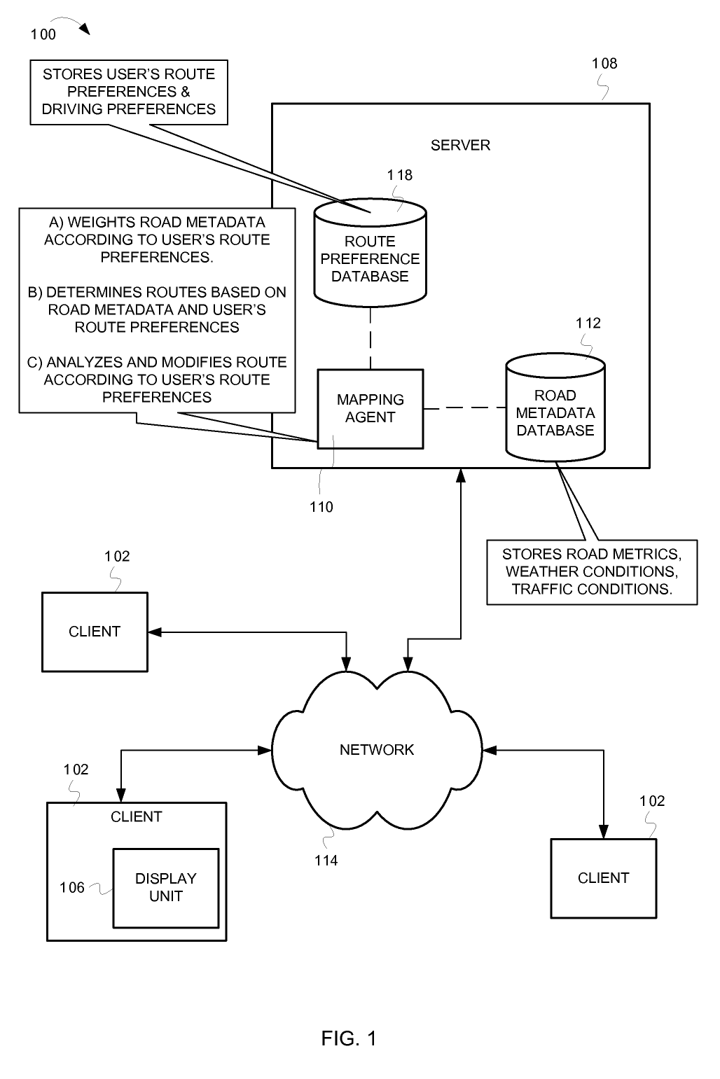

FIG. 1 is an example block diagram illustrating a client-server system configured to determine and present a simplified and comprehensible route. FIG. 1 describes embodiments wherein the mapping agent and related databases are located on a server. A client presents a route, which was determined at the server, to a user.

The system 100 includes a server 108 and clients 102. The server 108 comprises a mapping agent 110 coupled with a road metadata database 112 and a route preferences database 118. The mapping agent 110 synthesizes data from the route preferences database 118 and the road metadata database 112 to determine a route. The mapping agent 110 prompts a user to enter a set of route preferences via a display unit 106 on the client 102. The mapping agent 110 stores the set of route preferences in the route preferences database 118. The mapping agent 110 accesses the route preference database 118 and the road metadata database 112 to respectively retrieve route preferences and road metadata. The mapping agent 110 uses the retrieved route preferences and road metadata to determine a route from a starting point to a destination point, which most accommodates the user's route preferences based on the road metadata. The route comprises a set of waypoints between the starting point and the destination point. The route also comprises one or more paths between the starting point and the destination point. In some instances, a single road can be multiple paths (e.g., from the system's perspective, the road may comprise two or more waypoints and intersections and turns in the road may break up the road). In other instances, a path can comprise two or more roads.

The road metadata database 112 includes road information (e.g., speed limit, number of lanes, road turn angles, etc.). The road metadata database 112 can also include geographic points on a map (represented as latitudes and longitudes) representing a series of waypoints (e.g., points of interest, locations of highway exits, etc.). Road information can also include information derived from existing road data. For example, the mapping agent 110 can use maps and geo-coding to determine if the angle of a road intersection can be considered a “fork” or if it is “blind”, thus making turns difficult for a driver. A user's route preferences can comprise a starting point and a destination point, intermediate points to pass through along the journey, least left turns, minimum night time driving, left turns at big intersections only, etc. The user's route preferences are stored in the route preference database 118.

The mapping agent 110 may also access the road metadata database 112, determine various conditions associated with the roads (e.g., speed limit, detours, turn lanes, etc.), and use this information to determine the complexity of the route based on the user's preferences. The mapping agent 110 can determine multiple routes between the starting point and destination point, score the route based on complexity, and present the least complicated route. The scores associated with the multiple routes may be based on weights associated with each of the paths that comprise the routes. In some instances, the mapping agent 110 may determine (e.g., assign or modify) the weights by comparing the road metadata with the user's route preferences, while in other instances, the mapping agent 110 may allow the user to enter weights for certain paths (one or more roads between waypoints, segments of roads, etc.) along the route. The mapping agent 110 may also enable users to change route preferences after reviewing the route. The mapping agent 110 presents the determined route on the user's display unit 106.

The block diagram in FIG. 1 should not be used to limit embodiments as the functionality described with reference to FIG. 1 may be performed by blocks not shown in the figure. For example, although FIG. 1 depicts road information and route preferences being stored in the road metadata database 112 and the route preference database 118 respectively, the road information and route preferences may be stored as part of the mapping agent.

The server 108 and the clients 102 are connected to a communication network 114. The network 114 can include any technology suitable for passing communication between the clients and servers (e.g., Ethernet, 802.11n, SONET, etc.). Moreover, the network 114 can be part of other networks, such as cellular telephone networks, public-switched telephone networks (PSTN), cable television networks, etc. Additionally, the server 108 and clients 102 can be any suitable computing devices capable of executing software in accordance with the embodiments described herein.

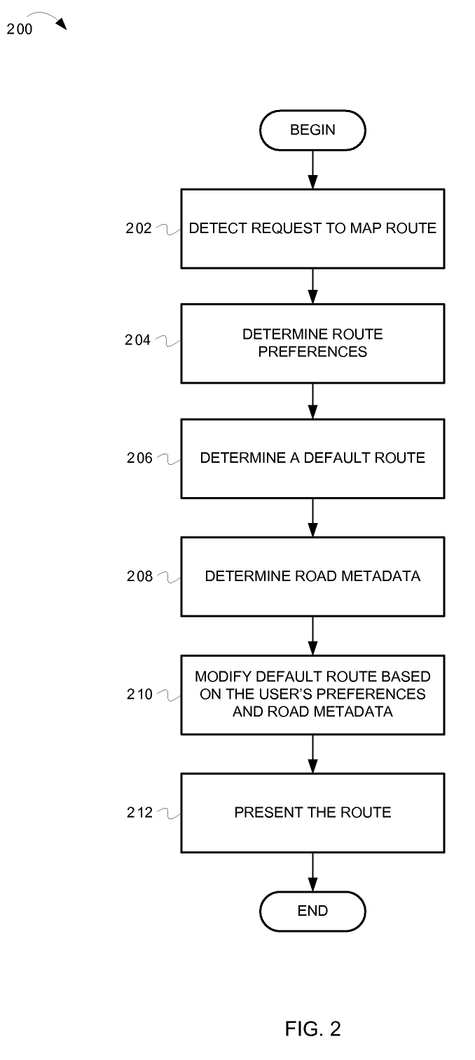

FIG. 2 is a flow diagram illustrating example operations for determining a tailored route for navigation. The following discussion will describe the flow 200 with reference to the client-server system of FIG. 1. The flow 200 begins at block 202.

At block 202, a mapping agent 110 detects a request to map a route. The request can be in response to a user clicking on a “calculate route” button, clicking on a destination point, etc. In some embodiments, users can also specify a starting point and a destination point. In other embodiments, users may specify only a destination point, allowing the mapping agent 110 to determine the users' location or use a pre-programmed starting point. The mapping agent 110 may also allow users to enter the starting point and the destination point in the form of geographical coordinates (e.g., latitudes and longitudes). The flow continues at block 204.

At block 204, the mapping agent 110 determines route preferences. The mapping agent 110 can retrieve the user's default route preferences from the route preference database 118. The mapping agent 110 can prompt the user to specify additional routing options to tailor the directions according to the user's route preferences. The mapping agent 110 can present, in the form of an interface, one or more routing options from which users may select (e.g., using sliders, drop down menus, toggle buttons, etc). Some examples of default routing preferences include shortest time, shortest distance, least use of freeways, least use of toll roads, etc. Examples of route preferences that the mapping agent can use to determine the most user-friendly set of directions are 1) use of major streets, 2) least turns, 3) preference to right turns, 4) least forks in the road, 5) least blind or “greater than 90 degree” turns, 6) least use of turns following bends (potential missed turns with limited visual of upcoming turns), 7) limited intersections with similarly named streets (e.g., Chalk Rock Cove vs. Chalk Rock Lane), 8) preference to larger streets, 9) preference to straighter streets, 10) preference to more significant intersections or those known to have lights or cross of two larger streets, 11) preference to commercial areas over residential areas (because it is likely to be marked well and may have more places to stop and ask for directions), 12) least use of “merge to the left/right”, 13) preference for turns or changes in course with closest available “turnarounds” if point was missed, 14) use of access roads over highways (balance of sitting through an extra light or two vs. potentially missing an exit), 15) time of day factor (for light). In some instances, the mapping agent 110 can also allow users to enter waypoints (roads, points of interest etc.) as intermediate destinations to pass through on a route. The flow continues at block 206.

At block 206, the mapping agent 110 determines a default route. The mapping agent 110 may generate a default route (based on, for example, the shortest distance) between the starting and destination points. The mapping agent can use the default route as a reference to generate an alternative route tailored to the user's route preferences. The mapping agent 110 can score the default route and generate the alternative tailored route if the default route falls below a pre-defined score (or exceeds a threshold). The mapping agent may present the default route if it is in accordance with the user's preferences, or may not present the default route if the alternate route is a better match. The mapping agent 110 can retrieve the user's default route preferences from the route preference database 118, and use these preferences to determine a route. In some instances, the mapping agent 110 can use a “great circle routing algorithm” to determine a route between two points. The mapping agent 110 may also use a suitable algorithm to search a graph of nodes (representing waypoints) and edges (representing paths between waypoints). Each edge can have a different weight associated with it. The mapping agent 110 can use Dijkstra's algorithm, the A* algorithm, or any suitable algorithm to determine the default path between the starting point and the destination point. The flow continues at block 208.

At block 208, the mapping agent 110 determines road metadata. Road metadata 112 can include information such as the road speed limit, road size, number of lanes, turn angles, etc. Road metadata 112 can also include information about the road's performance in severe weather conditions such as “unsafe to drive on road in snow”, “difficult to drive in heavy rain”, etc. In some instances, road metadata may also include current road conditions such as traffic conditions, roads undergoing repairs, detours, current ambient conditions (e.g., wind velocity, rain), etc. Road metadata can also comprise information such as number of commercial properties along the road, residential areas, etc. In some instances, road metadata for the same stretch of road may differ depending on the direction of traffic. For example, a blind turn in one direction may be a fork in the opposite direction. The flow continues at block 210.

At block 210, the mapping agent 110 modifies the default route based on the user's preferences and the road metadata 112. The edges (paths) between the starting point and destination point may be weighted depending on the user's preferences. In some instances, the same edge can have a different weight depending on the routing options selected by the user. For example, a path (along a major road) with multiple left turns may have a high weight if the user selects a “most use of major roads” option. The same path may have a low weight if the user selects a “least left turns” option. The mapping agent 110 can present the default route, highlight the potentially confusing areas along the route, and indicate that a less confusing, alternate route may be available. In one embodiment, the mapping agent 110 may determine a path between two adjacent waypoints along the default route and use the road metadata to determine whether the path satisfies the user's preferences. If the path is in accordance with the user's preferences, the mapping agent 110 may move on to the path between two subsequent waypoints. Otherwise, the mapping agent 110 may use a suitable routing algorithm to determine an alternate path between the two waypoints. For example, the user may have selected “least left turns” as one of the routing options. In checking the path between waypoints A and B, if the mapping agent 110 encounters a left turn in the path, it may calculate the next possible path from that point on assuming no left turn was made. In some embodiments, the mapping agent 110 may not determine and modify a default route, and may construct a route based only on the users' specific preferences. In some instances, every route may be associated with a score (e.g., a metric indicating the relative complexity of the route based on the weights associated with paths between waypoints along the route). The mapping agent 110 can determine more than one alternate route, score each route based on the user's preferences, and present the route with the least score. The mapping agent 110 may also present all the determined alternate routes, their corresponding scores, and time required to traverse each route and allow the user to choose a route. Scoring routes may enable users to compare routes and weigh the cost of drive time against the security of a less complex set of directions. In other instances, the mapping agent 110 may present simplified directions if the generated default route falls below a certain score. The flow continues at block 212.

At block 212, the mapping agent 110 presents the route on the user's display unit 106. The mapping agent 110 can send, to the display unit, a list of directions including distance to traverse before the next turn, exit numbers, road names, approximate time of arrival at destination, etc. The mapping agent 110 may also interface with the display unit 106 to present points of interest along a route. In some instances, users may also have the option of choosing a “complex” default route over a simplified route (e.g., the user may be familiar with the default path). The mapping agent 110 can determine whether the display unit 106 has an audio output (e.g., audio card, speakers, etc.) and present additional directions in the form of voice prompts. From block 212, the flow ends.

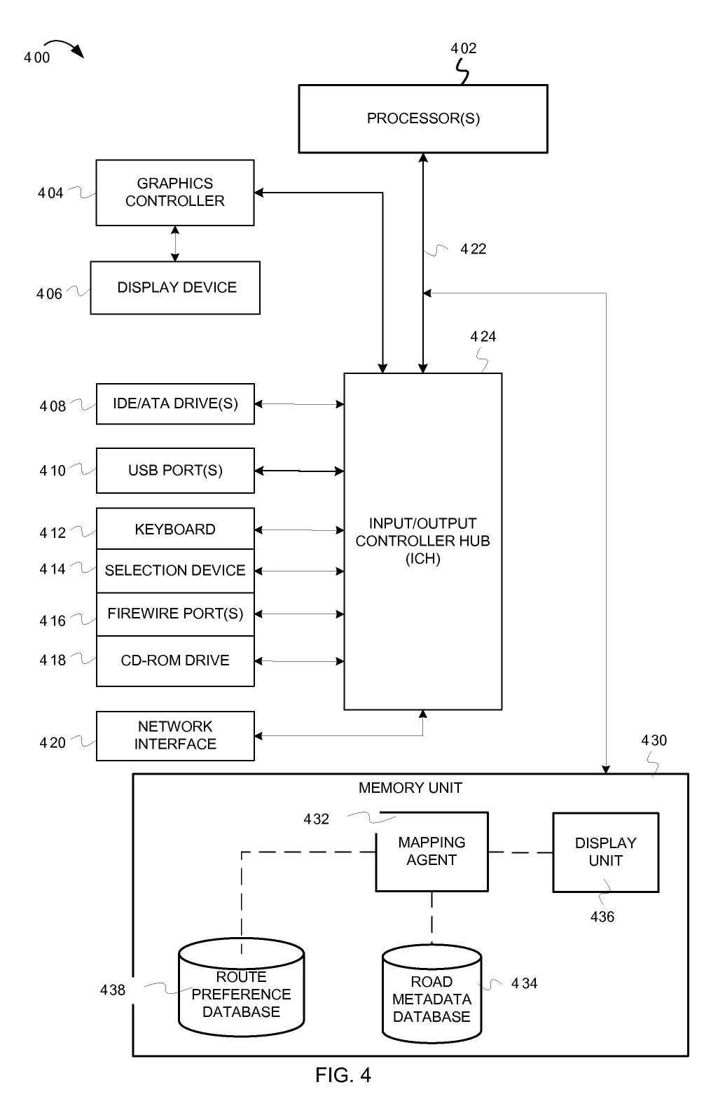

The depicted flow diagram is an example meant to aid in understanding embodiments and should not be used to limit the embodiments. For example, the sequence of operations described in FIG. 2 can also be performed by the embodiment in FIG. 4, where the mapping agent, road metadata database, and the display unit reside on the same machine. Also, embodiments may perform additional operations, fewer operations, operations in a different order, operations in parallel, and some operations differently.

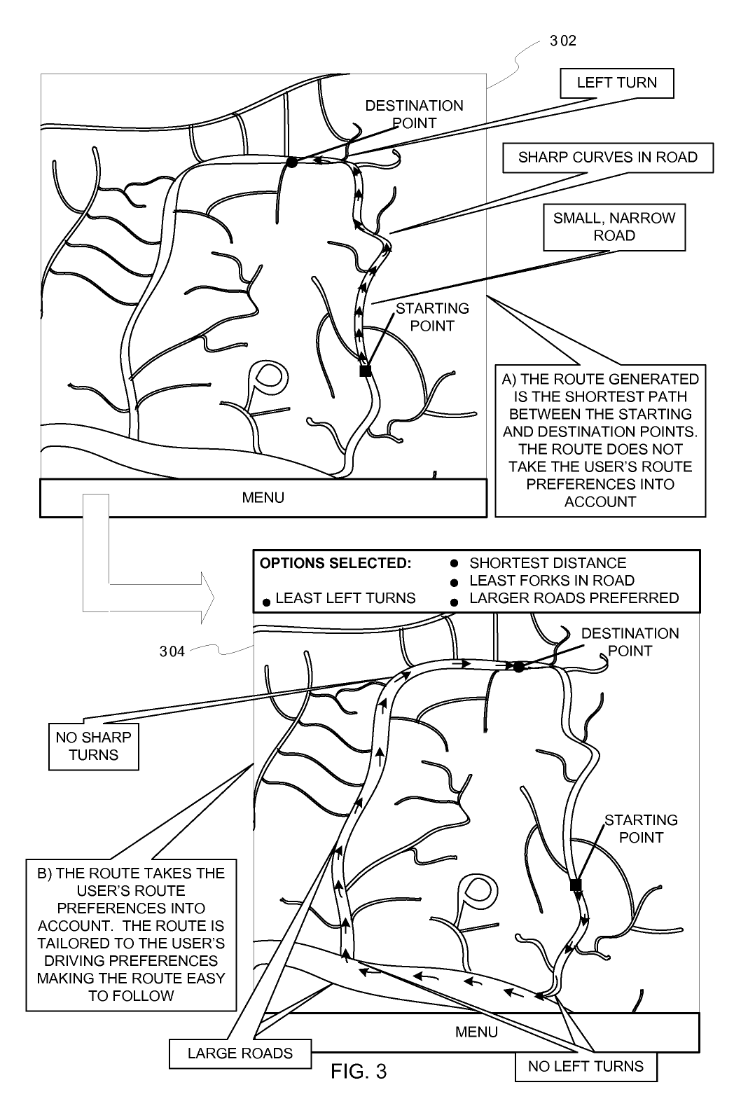

FIG. 3 is an example conceptual diagram depicting the reconfiguration of a route to reflect additional routing options. Map 302 depicts a route to travel from a starting point to a destination point. The route displayed in 302 presents the shortest and quickest route by default and does not take the user's preferences into account. This route may be generated by a traditional routing system or by the mapping agent as a default (reference) route. The route in map 302 has multiple left turns, sharp curves in the road, requires a driver to navigate through small and narrow roads, and has multiple forks in the road. The small road may also have a very low speed limit, may be a very windy street, and may have multiple offshoots of the primary road, with names similar to the primary road name, making the road confusing. This could make traversing the shortest path difficult because users may lose their way and waste time trying to get back on the road.

Alternatively, map 304 depicts a route to travel from the starting point to the destination point by an alternate route, determined by the mapping agent 110, based on a user's preferences. As shown in 304, the user's preferences include a shortest route, a least number of forks in the roads, larger roads, and least left turns. In 304, the mapping agent compares the road metadata with the user's preferences and determines an alternate route. The mapping agent may also use the user's preferences and road metadata to modify the route presented in 302. The route presented in 304 makes use of two large roads, does not involve any left turns, and has no sharp curves and confusing forks in the road. This route is tailored to the user's driving preferences and may therefore prevent the user from making a mistake while following directions. The route presented in 304 is longer and would take the user longer to traverse as compared to the route 302. However, the route 304 may be simple and easier to follow, from the user's perspective, because it is based on the user's preferences.

FIG. 4 is an example block diagram illustrating a standalone system configured to determine and present a tailored route. FIG. 4 describes embodiments in which the mapping agent, the related databases, and the display unit are located on the same machine.

A computer system 400 includes a processor 402. The processor 402 is connected to an input/output controller hub 424 (ICH), also known as a south bridge, via a bus 422. A memory unit 430 interfaces with the processor 402 and the ICH 424. The main memory unit 430 can include any suitable random access memory (RAM), such as static RAM, dynamic RAM, synchronous dynamic RAM, extended data output RAM, etc.

In one embodiment, the memory unit 430 includes a mapping agent 432 coupled with a road metadata database 434, a route preference database 438, and a display unit 436. The road metadata database 434 comprises road information including speed limit, number of lanes, road turn angles, points of interest, driving conditions at different times of day and different weather conditions, etc. The mapping agent 432 prompts users to enter their preferences including destination and route preferences (e.g., use of major streets, least forks in the road, etc.) via the display unit 436. The user's route preferences are stored in the route preference database 438. The mapping agent 432 accesses the route preference database 438 and determines the user's preferences. The mapping agent 432 also accesses the road metadata database 434, determines various conditions associated with the roads (e.g., speed limit, detours, etc.), calculates a favorable route between the starting point and the destination point, and presents the route on the display unit 436.

The ICH 424 connects and controls peripheral devices. In FIG. 4, the ICH 424 is connected to IDE/ATA drives 408 (used to connect external storage devices) and to universal serial bus (USB) ports 410. The ICH 424 may also be connected to a keyboard 412, a selection device 414, firewire ports 416 (for use with video equipment), CD-ROM drive 418, and a network interface 420. The ICH 424 can also be connected to a graphics controller 404. The graphics controller is connected to a display device (e.g., monitor). In some embodiments, the computer system 400 can include additional devices and/or more than one of each component shown in FIG. 4 (e.g., video cards, audio cards, peripheral devices, etc.). For example, in some instances, the computer system 400 may include multiple processors, multiple cores, multiple external CPU's. In other instances, components may even be integrated or subdivided.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

While the embodiments are described with reference to various implementations and exploitations, it will be understood that these embodiments are illustrative and that the scope of the inventive subject matter is not limited to them. In general, techniques for generating simplified routes for electronic maps are described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting a request to map a route, wherein the route is a set of waypoints between a starting point and a destination point on an electronic map and wherein a waypoint is a geographic point on the electronic map;
determining one or more route preferences;
determining road metadata, wherein the road metadata is associated with one or more paths between the starting point and the destination point;
determining a route based on the route preferences and the road metadata; and
presenting the route.

2. The method of claim 1, wherein the determining the route based on the route preferences and the road metadata also comprises:
determining a default route, wherein the default route is based on a set of default route preferences;
modifying the default route based on route preferences and road metadata; and
presenting the modified route.

3. The method of claim 2, wherein default route preferences comprise any one of shortest distance, least amount of travel time, least use of freeways, and least use of toll roads.

4. The method of claim 1, wherein the route preferences comprise any one or more of use of major streets, least turns, preference to right turns, least forks in the road, least blind turns, least use of turns following bends, limited intersections with similarly named streets, preference to larger streets, preference to straighter streets, preference to significant intersections, preference to commercial areas over residential areas, least merging onto highways, use of access roads over highways, and time of day factor.

5. The method of claim 1, wherein road metadata comprises information associated with one or more roads and comprises any one or more of a road's speed limit, road size, turn angles, traffic conditions, road construction, detours, number of commercial properties, and weather conditions.

6. The method of claim 1, wherein the presenting the route also comprises presenting one or more confusing areas along the default path, wherein the confusing areas are determined based on the user's preferences.

7. A method comprising:
determining a starting point and a destination point on an electronic map;
determining one or more route preferences;
evaluating a plurality of paths from the starting point to the destination point based, at least in part, on weights associated with the plurality of paths and road data associated with the plurality of paths, with respect to the determined one or more route preferences;
selecting those of the plurality of paths that comport most with the determined one or more preferences based on said evaluating; and
storing the selected paths of the plurality of paths as a route from the starting point to the destination point in one or more machine-readable media.

8. The method of claim 7, wherein the evaluating the plurality of paths is based on user-defined weights associated with one or more of the route preferences.

9. The method of claim 7, also comprising:
determining one or more routes between the starting point and the destination point from the plurality of evaluated paths;
associating, with the one or more determined routes, a score based on the complexity of the determined routes, wherein the complexity is dependent at least in part on the weights associated with the plurality of paths;
determining a route, from the one or more determined routes, with the least score; and
presenting the route with the least score.

10. The method of claim 9, also comprising:
presenting the plurality of determined routes along with the score associated with the determined routes and time required to traverse the plurality of routes;
detecting a selection of a route from the plurality of determined routes; and
presenting the selected route.

11. The method of claim 9, further comprising:
detecting a modification in weights associated with the plurality of paths;
dynamically determining one or more alternate routes based on the modified paths;
determining the scores associated with the one or more determined alternate routes.

12. One or more machine-readable media having stored therein a program product, which when executed by a set of one or more processors causes the set of one or more processors to perform operations that comprise:
determining a starting point and a destination point on an electronic map;
determining one or more route preferences;
evaluating a plurality of paths from the starting point to the destination point based, at least in part, on weights associated with the plurality of paths and road data associated with the plurality of paths, with respect to the determined one or more route preferences;
selecting those of the plurality of paths that comport most with the determined one or more preferences based on said evaluating; and
storing the selected paths of the plurality of paths as a route from the starting point to the destination point.

13. The machine-readable media of claim 12, wherein said operation of evaluating the plurality of paths is based on user-defined weights associated with one or more of the route preferences.

14. The machine-readable media of claim 12, wherein the operations further comprise:
determining one or more routes between the starting point and the destination point from the plurality of evaluated paths;
associating, with the one or more determined routes, a score based on the complexity of the determined routes, wherein the complexity is dependent at least in part on the weights associated with the plurality of paths;
determining a route, from the one or more determined routes, with the least score; and
presenting the route with the least score.

15. The machine-readable media of claim 14, wherein the operations further comprise:
presenting the plurality of determined routes along with the score associated with the determined routes and time required to traverse the plurality of routes;
detecting a selection of a route from the plurality of determined routes; and
presenting the selected route.

16. The machine-readable media of claim 14, wherein the operations further comprise:
detecting a modification in weights associated with the plurality of paths;
dynamically determining one or more alternate routes based on the modified paths;
determining the scores associated with the one or more determined alternate routes.

17. The machine-readable media of claim 12, wherein the route preferences comprise any one or more of use of major streets, least turns, preference to right turns, least forks in the road, least blind turns, least use of turns following bends, limited intersections with similarly named streets, preference to larger streets, preference to straighter streets, preference to significant intersections, preference to commercial areas over residential areas, least merging onto highways, use of access roads over highways, and time of day factor.

18. An apparatus comprising:
a set of one or more processors;
a road metadata database including information about one or more roads;
a mapping agent operable to,
determine a starting point and a destination point on an electronic map;
determine one or more route preferences;
evaluate a plurality of paths from the starting point to the destination point based, at least in part, on weights associated with the plurality of paths and road data associated with the plurality of paths, with respect to the determined one or more route preferences;
select those of the plurality of paths that comport most with the determined one or more preferences based on said evaluating; and
store the selected paths of the plurality of paths as a route from the starting point to the destination point.

19. The apparatus of claim 18, wherein the mapping agent is further operable to,
determine one or more routes between the starting point and the destination point from the plurality of evaluated paths;
associate, with the one or more determined routes, a score based on the complexity of the determined routes, wherein the complexity is dependent at least in part on the weights associated with the plurality of paths;
determine a route, from the one or more determined routes, with the least score; and
present the route with the least score.

20. The apparatus of claim 18, wherein the mapping agent comprises one or more machine-readable media.
